(19) United States
(12) Patent Application Publication
(10) Pub. No.: US 2013/0177416 A1
(43) Pub. Date: Jul. 11, 2013

(54) WIND TURBINE AND METHOD FOR OPERATING SAID WIND TURBINE WHEREIN A RISK OF ICING IS DETERMINED ON THE BASIS OF METEOROLOGICAL DATA

(71) Applicant: Nordex Energy GmbH, Hamburg (DE)

(72) Inventors: Oskar Renschler, Delingsdorf (DE); Melanie Stock, Hamburg (DE)

(73) Assignee: Nordex Energy GmbH, Hamburg (DE)

(21) Appl. No.: 13/737,690

(22) Filed: Jan. 9, 2013

(30) Foreign Application Priority Data
Jan. 10, 2012 (EP) 12000119.3
Feb. 9, 2012 (EP) 12000836.2

(51) Int. Cl. F03D 11/00

(52) U.S. Cl. CPC F03D 11/0025
USPC 416/1; 416/39

(57) ABSTRACT

A method for operating a wind turbine includes detecting a surface temperature of a component of the wind turbine and determining a risk of icing of the component of the wind turbine. A frost or dew point temperature of the ambient air is determined and a difference between the surface temperature and the frost or dew point temperature is evaluated during the determination of the risk of icing.

### CROSS REFERENCE TO RELATED APPLICATION

This application claims priority of European patent application Nos. 12000119.3 and 12000836.2,
filed Jan. 10, 2012 and Feb. 9, 2012, respectively, and the entire contents of both applications are incorporated herein by reference.

### FIELD OF THE INVENTION

The invention relates to a method for operating a wind turbine in which a surface temperature is detected and a risk of icing of a component of a wind turbine is determined.

### BACKGROUND OF THE INVENTION

At some locations of wind turbines, high humidity and temperatures around the freezing point can again and again lead to the icing of components of the wind turbine, in particular the rotor blades. Such icing can impair the operation of the wind turbine, in particular reduce the aerodynamic efficiency of the rotor blades. Beyond the corresponding loss in yield, aerodynamic imbalances can arise which can reduce the service life of components.

Thus, the service life and efficiency of a wind turbine at locations at which icing occurs can be increased through an effective de-icing. In particular, active and passive de-icing systems can be used to de-ice rotor blades. Active de-icing systems, in particular, have electrically operated heating units. Such a heating unit has, for example, been disclosed in U.S. Pat. No. 6,145,787 A.

In order to be able to use active de-icing systems in a targeted fashion and without excessive energy consumption it is of crucial importance to detect ice formation as it is beginning or a risk of icing in a timely manner. For this purpose U.S. patent application publication 2011/0089692 A1 discloses measuring the meteorological data of temperature, relative humidity and solar radiation in the vicinity of the wind turbine and determining the likelihood of icing on the basis thereof. In the known method it is also monitored whether the wind turbine is achieving its expected performance value. The wind turbine can be switched off in dependence on performance deviations and the determined risk of icing.

Another method for recognizing ice on the rotor blades of a wind turbine is disclosed in U.S. Pat. No. 7,086,834 B2. In this known method, the temperature and the humidity are also monitored in addition to information relating to precipitation and the type of precipitation. Furthermore, with the aid of strain gauges on the rotor blades, it is determined whether a mass imbalance between the rotor blades is present. If such a “blade mass anomaly” is observed and the monitored meteorological data are compatible with a formation of ice, a signal that an icing of the rotor blades exists or is probable is outputted.

U.S. Pat. No. 8,200,451 B2 discloses a method for recognizing a risk of icing on the rotor blades of a wind turbine. In this known method a temperature sensor and a rain sensor are arranged on an aerodynamic surface of the rotor blade. The rain sensor determines whether water is present on the surface. If that is the case and the temperature is below a specific value, a signal that icing is likely is outputted.

### SUMMARY OF THE INVENTION

Based on the above, it is an object of the invention to provide a method for operating a wind turbine with which a risk of icing can be simply and exactly determined.

The object is achieved by a method for operating a wind turbine having the following steps: detecting a surface temperature of a component of the wind turbine; determining a risk of icing of the component of the wind turbine; determining a risk or dew point temperature of the ambient air; and, when determining the risk of icing, evaluating a difference between the surface temperature and the frost or dew point temperature.

The detecting of the surface temperature can be done with a temperature sensor which is arranged directly on the surface. This sensor can be in thermal contact with the surface. A small distance between the surface and the temperature sensor is also possible so long as the temperature detected by the temperature sensor essentially corresponds to the local surface temperature. The surface can be an aerodynamic surface. The component of the wind turbine can, for example, be a rotor blade.

The temperature sensor is preferably arranged in a region of the surface of the component which is particularly prone to icing. In the case of a rotor blade this can, for example, be the profile nose edge or a section of the suction side of the rotor blade. The invention is based on the idea that the surface temperature of the component can be lower than the temperature of the ambient air. This effect in particular occurs on the surfaces of rotor blades.

The risk of icing is a measure for whether an icing of the component of the wind turbine can be expected. Risk of icing can be simple yes/no information or a quantitative value which corresponds to a likelihood of icing. In the latter case, if a risk of icing is determined, measures, for example switching on a heater, can be taken when a specific likelihood value is exceeded.

The risk of icing is always related to the component of the wind turbine whose surface temperature is being detected. It is understood that multiple temperature sensors can also be arranged on different sections of a surface or multiple surfaces of one or more components of the wind turbine. In this case a risk of icing can be determined at each location at which the surface temperature is detected.

Furthermore, in the invention a frost point temperature or a dew point temperature of the ambient air is determined. These temperatures are a measure for when the relative humidity of the ambient air assumes a value of 100%, that is, is saturated with water vapor. When the ambient air cools to below the frost or dew point, a precipitation of the moisture occurs. An example to illustrate these interrelationships: at a temperature of 20° C. air can hold approximately 9.4 g of water per cubic meter. If at specific weather conditions at this temperature only 4.7 g water are contained in a cubic meter of air, the relative humidity is thus approximately 50%. If this air cools to a temperature of approximately −0.5° C., the relative humidity reaches its maximum of 100% because a cubic meter air at this temperature can then only hold approximately 4.7 g of water.

At temperatures of less than approximately −0.5° C. there is, for this reason, precipitation of the moisture.

In dependence on the temperature, two different processes can be differentiated: at temperatures above the freezing point of water, a precipitation in the form of water droplets occurs. This process is referred to as condensation. The associated temperature which characterizes the condensation point is referred to as the dew point temperature.

At temperatures below the freezing point of water, a precipitation in the form of ice crystals occurs. This process is referred to as resublimation because the reverse process, namely a direct change from solid into the gaseous aggregate state, is referred to as sublimation. The associated temperature which characterizes the resublimation point is referred to as the frost point temperature.

The dew point temperature and the frost point temperature are different from each other because the vapor pressures of water over solid water (ice) are different than over liquid water.

In the invention, a difference between the detected surface temperature and the frost or dew point temperature determined for the ambient air is evaluated. Thus, during the determination of the risk of icing it is considered whether the ambient air is such that in the case of a cooling off to the detected surface temperature—which upon contact of the ambient air with the surface occurs more or less completely—a precipitation of the water contained in the ambient air must be expected.

In comparison to the known process described above with a rain sensor there thus is no wait to see whether there is droplet formation and thus an activation of the rain sensor, rather it is evaluated independently thereof whether the conditions for moisture precipitation on the surface are present. This enables a more exact determination of the risk of icing.

In one embodiment, a risk of icing is only recognized when the surface temperature is above the frost or dew point temperature by less than a predetermined amount. The predetermined amount can, for example, be in the range of 1° to 4°. For icing, it is a necessary but not sufficient condition that the surface temperature is less than a predetermined value above the frost or dew point temperature. In the case of surface temperatures far above the frost or dew point temperature, for example more than 4° over, it can be excluded that moisture from the air will precipitate on the surface. Moisture already present on the surface would not generally also lead to a sustained icing but rather would be absorbed by the ambient air via evaporation or sublimation. The maintaining of a “distance” at the value of the predetermined amount between surface temperature and frost or dew point temperature is a precautionary measure, which can take account of measurement errors, fast changes in the surface temperature and/or the frost or dew point temperature.

In one embodiment, a risk of icing is only recognized when the surface temperature is below the frost or dew point temperature. Here, this also involves a necessary but not sufficient condition for an icing. If the surface temperature is below the frost or dew point temperature, precipitation of the moisture on the surface is to be expected with a high likelihood.

In one embodiment, a risk of icing is only recognized when the surface temperature is below a predetermined minimum temperature. Here, this involves a further necessary but not sufficient condition for icing. The predetermined minimum temperature can for example be in the range of 0° C. to 4° C. At higher surface temperatures generally no ice will form even in the case of a condensation of moisture on the surface.

In one embodiment, the difference between the surface temperature and the frost point temperature is evaluated in the case of surface temperatures below a predetermined limit value. Because of the different vapor pressures over water and over ice, the frost point temperature is generally a little higher than the dew point temperature. If precipitation through resublimation is to be expected below a certain surface temperature, for example corresponding to the freezing point of water, it is for this reason safer and more exact to apply the frost point temperature instead of the dew point temperature when establishing the risk of icing.

In one embodiment, the temperature of the ambient air, the relative humidity of the ambient air and/or the pressure of the ambient air are detected in order to determine the frost or dew point temperature. On the basis of the mentioned measurement values, the frost point temperature or the dew point temperature can be easily calculated.

In one embodiment, the detecting of the temperature, the relative humidity and/or the pressure of the ambient air are measured at a distance from the component of the wind turbine. In the case of the frost and dew point temperature of the ambient air values are involved which are largely independent of location. Thus, the moisture content of the ambient air in the region of a nacelle of the wind turbine is generally only minimally different from the moisture content of the ambient air on the ground or in the region of a rotor blade. Appropriate existing differences can often be attributed to the pressure at the relevant height and can be considered during the determination of the frost or dew point temperature. For this reason, the detecting of measurement values, on whose basis the frost or dew point temperature is determined, can be done at an arbitrary location, in particular at a distance from the component for which the risk of icing is to be determined. The arrangement of the corresponding measurement devices can for this reason be done according to practical considerations, for instance in a weather station on the ground, on the rotor or at or on the nacelle. All sensors used for the determination of the frost or dew point temperature can be arranged at the same location.

In one embodiment a heating unit for the component of the wind turbine is activated when a risk of icing is recognized. This can, for example, involve a rotor blade heater. The heating unit can, in particular, be operated electrically.

In one embodiment, the wind turbine is shut down when a risk of icing is recognized. While a loss of yield is a result of this simple measure, damage to the installation as a result of icing is nonetheless avoided. This solution is particularly suited for locations at which a risk or icing only occurs very rarely.

The above mentioned object is also achieved by the wind turbine having the features: a sensor for detecting a surface temperature of a component of the wind turbine; a controller connected to the sensor for detecting the surface temperature of the component and is configured to determine a risk of icing of the component of the wind turbine; a measuring arrangement for determining a frost or dew point temperature of the ambient air, the measuring arrangement being connected to the controller, wherein the controller is configured to evaluate a difference between a detected surface temperature and a determined frost or dew point temperature when determining the risk of icing.

The wind turbine is, in particular, provided for performing the method according to the invention. As a result of the evaluation of the difference between a detected surface temperature and a determined frost or dew point temperature when determining the risk of icing, the precision during the determination of the risk of icing can be improved in a simple manner.

In one embodiment, the measuring arrangement for determining the frost or dew point temperature includes a temperature sensor which detects the temperature of the ambient air, a humidity sensor which detects the relative humidity of the ambient air, and/or a pressure sensor which detects the pressure of the ambient air. On the basis of the corresponding measurement values, the frost or dew point temperature can be calculated. For this, reference can be made to the above descriptions of the corresponding method features.

In one embodiment, the temperature sensor, the humidity sensor and/or the pressure sensor are arranged at a distance from the component of the wind turbine. For this, reference can be made to the above descriptions of the corresponding method features.

In one embodiment, the measuring arrangement for determining the frost or dew point temperature is a combined transducer which detects the temperature, the relative humidity and the pressure of the ambient air. Such combined transducers are known from meteorology and can easily and reliably provide the measurement data necessary for determining the frost or dew point temperature.

In one embodiment, the wind turbine has a heating unit and the controller is configured to activate the heating unit when a risk of icing is recognized. For this, too, reference can be made to the above descriptions of the corresponding method features. The heating unit can, for example, be arranged on a surface of a rotor blade.

### BRIEF DESCRIPTION OF THE DRAWING

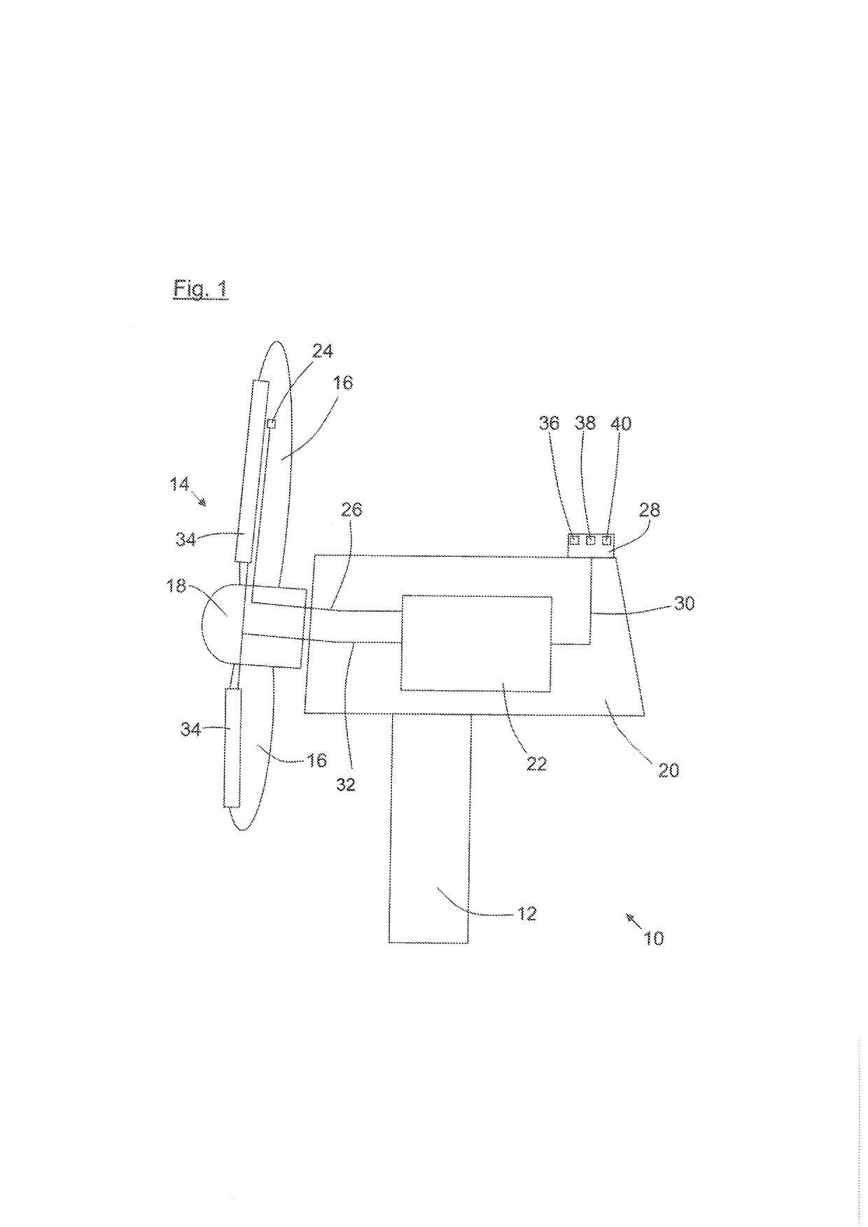

The invention will now be described with reference to the single figure of the drawing (FIG. 1) which shows a wind turbine according to the invention.

### DESCRIPTION OF THE PREFERRED EMBODIMENTS OF THE INVENTION

FIG. 1 shows a wind turbine 10 according to the invention which includes a tower 12 shown only partially, a rotor 14 having an essentially horizontal axis and three rotor blades 16 as well as a rotor hub 18. Further, the wind turbine 10 has a nacelle 20 in which a controller 22 is arranged. The controller 22 can be a part of the central operating control.

The wind turbine 10 has a sensor 24 for detecting a surface temperature of a component of the wind turbine 10. In the shown embodiment, the sensor 24 detects the surface temperature on an aerodynamic surface on the suction side of a rotor blade 16. The sensor 24 is in thermal contact with the surface of the rotor blade 16. The sensor 24 is connected to the controller 22 via an electrical line 26 which can have a slip ring connection.

Further, the wind turbine includes a combined transducer 28. The combined transducer is arranged on the nacelle 20 and is connected to the controller 22 via an electrical line 30. The combined transducer 28 detects the temperature, the relative humidity and the pressure of the ambient air. For this purpose the combined transducer has a temperature sensor 36, a humidity sensor 38 and a pressure sensor 40. The combined transducer 28 provides the corresponding measurement values to the controller 22. The controller 22 determines the frost or dew point temperature of the ambient air on the basis of these measurement values. Alternatively, this can also occur within the measurement arrangement or the combined transducer.

For determining a risk of icing on the rotor blades the controller 22 then evaluates a difference between the surface temperature detected on the rotor blade 16 by the sensor 24 and the frost or dew point temperature determined with the combined transducer 28.

The controller 22 is connected to heating elements 34 arranged on the rotor blades 16 via an electrical line 32. These heating elements 34 are activated when a risk of icing is present.

It is understood that the foregoing description is that of the preferred embodiments of the invention and that various changes and modifications may be made thereto without departing from the spirit and scope of the invention as defined in the appended claims.

### LIST OF REFERENCE SIGNS USED

10 Wind turbine
12 Tower
14 Rotor
16 Rotor blade
18 Rotor hub
20 Nacelle
22 Controller
24 Sensor for detecting the surface temperature
26 Line
28 Combined transducer
30 Electrical line
32 Electrical line
34 Heating unit
36 Temperature sensor
38 Humidity sensor
40 Pressure sensor

What is claimed is:

1. A method for operating a wind turbine comprising the steps of:
detecting a surface temperature of a component of the wind turbine;
determining whether a risk of icing of the component of the wind turbine is present;
determining a frost point temperature or a dew point temperature of the ambient air; and,
evaluating a difference between the surface temperature of the component and the frost or dew point temperature when determining the risk of icing.

2. The method of claim 1, wherein a risk of icing is only determined when the surface temperature is less than a predetermined amount above the frost or dew point temperature.

3. The method of claim 1, wherein a risk of icing is only determined when the surface temperature is below the frost or dew point temperature.

4. The method of claim 1, wherein a risk of icing is only determined when the surface temperature is below a predetermined minimum temperature.

5. The method of claim 1, wherein the difference between the surface temperature and the frost point temperature is evaluated when the surface temperature is below a predetermined minimum value.

6. The method, of claim 1 further comprising the step of detecting at least one of the temperature of the ambient air, the relative humidity of the ambient air and the pressure of the ambient air for the determination of the frost or dew point temperature.

7. The method of claim 6, wherein the step of detecting at least one of the temperature of the ambient air, the relative humidity of the ambient air and the pressure of the ambient air is performed at a distance from the component of the wind turbine.

8. The method of claim 1 further comprising the step of activating a heating unit for the component when a risk of icing is determined.

9. The method of claim 1 further comprising the step of shutting off the wind turbine when a risk of icing is determined.

10. A wind turbine comprising:
a wind turbine component having a surface;
a sensor configured to detect a temperature at said surface of said wind turbine component;
a control unit operatively connected to said sensor and configured to determine a risk of icing of said component;
a measurement arrangement operatively connected to said control unit and configured to determine one of a frost point temperature and a dew point temperature of the ambient air; and,
said control unit being further configured to evaluate a difference between said surface temperature and the frost or dew point temperature when determining said risk of icing.

11. The wind turbine of claim 10, wherein said measurement arrangement includes at least one of the following for determining said frost or dew point temperature: a temperature sensor configured to detect the temperature of the ambient air, a humidity sensor configured to detect the relative humidity of the ambient air, and a pressure sensor configured to detect the pressure of the ambient air.

12. The wind turbine of claim 11, wherein said temperature sensor, humidity sensor, and/or pressure sensor are arranged at a distance from said component of the wind turbine.

13. The wind turbine of claim 10, wherein said measurement arrangement is a combined transducer configured to detect the temperature, relative humidity and pressure of the ambient air.

14. The wind turbine of claim 10 further comprising:
a heating unit; and,
said control unit is further configured to activate said heating unit when a risk of icing is detected.

15. The wind turbine of claim 10 further comprising:
a heating unit configured to heat the component of the wind turbine; and,
said control unit is configured to activate said heating unit when a risk of icing is detected.
